(19) United States
(12) Patent Application Publication
(10) Pub. No.: US 2016/0091986 A1
(43) Pub. Date: Mar. 31, 2016

(54) HANDHELD DEVICE, MOTION OPERATION METHOD, AND COMPUTER READABLE MEDIUM

(71) Applicants: LITE-ON ELECTRONICS (GUANGZHOU) LIMITED, Guangzhou (CN); LITE-ON TECHNOLOGY CORPORATION, Taipei City (TW)

(72) Inventors: CHING-HUI CHEN, NEW TAIPEI CITY (TW); YI-CHUNG LO, TAIPEI CITY (TW); ZONG-SIAN LI, TAIPEI CITY (TW)

(21) Appl. No.: 14/809,144

(22) Filed: Jul. 24, 2015

(30) Foreign Application Priority Data
Sep. 29, 2014 (CN) 201410515868.5

(51) Int. Cl. G06F 3/0346; H04M 1/02; G06F 3/0482; G06F 1/16; G06F 3/0481

(52) U.S. Cl. CPC G06F 3/0346; G06F 1/1686; G06F 1/1694; G06F 3/04817; G06F 3/0482; G06F 1/1613; H04M 1/0281; G06F 2200/1637

(57) ABSTRACT

A handheld device includes a memory module, a sensing module and a processing module. The processing module is coupled to the sensing module and the memory module. The memory module stores a plurality of applications. The sensing module detects a motion of the handheld device and provides a sensing signal. The processing module executes at least one of the plurality of applications and receives the sensing signal. When the handheld device enters a motion operation mode and the processing module receives the sensing signal from the sensing module, the processing module controls the handheld device to execute a specific function according to at least one of the applications being executed and the sensing signal received by the handheld device.

### BACKGROUND

1. Technical Field

The present invention relates to a handheld device and, more particularly, to a handheld device a user can apply a motion to thereof, a motion operation method and a computer readable medium.

2. Description of Related Art

In the modern society, handheld devices such as smart phones and tablet personal computers (PCs) have become indispensable to daily life. Neither smart phones nor tablet PCs provide substantial buttons. Instead, the handheld devices are touch-controlled. Furthermore, with the rapid development of touch displays, the screen of a handheld device is getting bigger so that it is more convenient for the user to read electronic books, watch video clips, or access images through the handheld device.

However, with the increase of the size of the screen, the overall size of the handheld device increases. As a result, the user will not be able to use the handheld device with only one hand if he/she is carrying something heavy at the same time with the other hand. Accordingly, there is a need to provide a handheld device that can be operated with a single hand.

### SUMMARY

One embodiment of the present invention provides a handheld device. The handheld device includes a memory module, a sensing module and a processing module. The processing module is coupled to the sensing module and the memory module. The memory module stores a plurality of applications. The sensing module detects a motion of the handheld device to provide a sensing signal. The processing module executes the plurality of applications and receives the sensing signal. When the handheld device enters a motion operation mode and the processing module receives the sensing signal from the sensing module, the processing module controls the handheld device to execute a specific function according to the application being executed and the sensing signal received by the handheld device.

One embodiment of the present invention further provides a motion operation method. The motion operation method is applicable to a handheld device, and the handheld device is used for executing a plurality of applications. When the handheld device enters a motion operation mode, the handheld device executes the motion operation method. The motion operation method includes the steps as follows. A corresponding sensing signal is provided according to a motion of the handheld device. The handheld device executes a specific function according to the application being executed by the handheld device and the sensing signal.

One embodiment of the present invention further provides a computer readable medium recording at least a segment of source codes, capable of using a handheld device to read the source codes to execute the motion operation method.

According to the above, the present invention provides a handheld device and a motion operation method that allows a user to control the handheld device through a motion of the handheld device without pressing the buttons or touching the screen of the handheld device. In other words, the user only has to move the handheld device with different motions, so that the handheld device is able to execute specific functions, to improve the convenience of controlling the handheld device.

In order to further understand the techniques, means and effects of the present disclosure, the following detailed description and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram showing a handheld device according to one embodiment of the present invention;

FIG. 2 is a schematic diagram showing an application menu displayed on a handheld device according to one embodiment of the present invention;

FIG. 3A is a schematic diagram showing cursors displayed on a handheld device according to one embodiment of the present invention;

FIG. 3B is a schematic diagram showing selection and copying of words executed by a handheld device according to one embodiment of the present invention;

FIG. 4 is a schematic diagram showing page turning executed by a handheld device according to one embodiment of the present invention;

FIG. 5A is a schematic diagram showing image capturing executed by a handheld device according to one embodiment of the present invention;

FIG. 5B is a schematic diagram showing focusing on a foreground by a handheld device according to one embodiment of the present invention;

FIG. 5C is a schematic diagram showing focusing on a background by a handheld device according to one embodiment of the present invention;

FIG. 6 is a schematic diagram of a look-up table according to one embodiment of the present invention; and

FIG. 7 is a flow chart of a motion operation method for a handheld device according to one embodiment of the present invention.

### DESCRIPTION OF THE EXEMPLARY EMBODIMENTS

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood that the same or equivalent functions may be accomplished by different embodiments that are also intended to be encompassed within the scope of the present disclosure. It should be understood, although the terms first, second, third, etc., may be used to describe various elements, steps, directions, values, modes, etc., these elements, steps, directions, values, modes, etc. should not be limited by such terms.

The conventional handheld device fails to meet the user's demands because the user cannot control the handheld device without pressing buttons or touching the screen of the handheld device.

Therefore, to meet the user's demands, the present invention provides a handheld device and a motion operation method thereof. The user is able to switch the operation modes of the handheld device. When the handheld device is switched from a general operation mode to a motion operation mode, the user can control the handheld device without pressing the buttons or touching the screen thereof. Moreover, with respect to the motion operation method, one embodiment of the present invention further provides a computer readable medium capable of recording at least one segment of source codes. The handheld device can read the at least one segment of source codes to execute the motion operation method.

As stated above, when the handheld device is in the motion operation mode, the handheld device correspondingly provides a sensing signal according to the state of motion, and then selects a corresponding command according to the application being executed and the sensing signal provided. For example, the handheld device selects a corresponding command from an embedded look-up table, and executes a specific function according to the selected command. The user only has to apply different motions to move the handheld device, and as a consequence, the handheld device is able to execute specific functions, which improves the convenience of controlling the handheld device.

The handheld device and the motion operation method thereof in one embodiment of the present invention will now be described in detail.

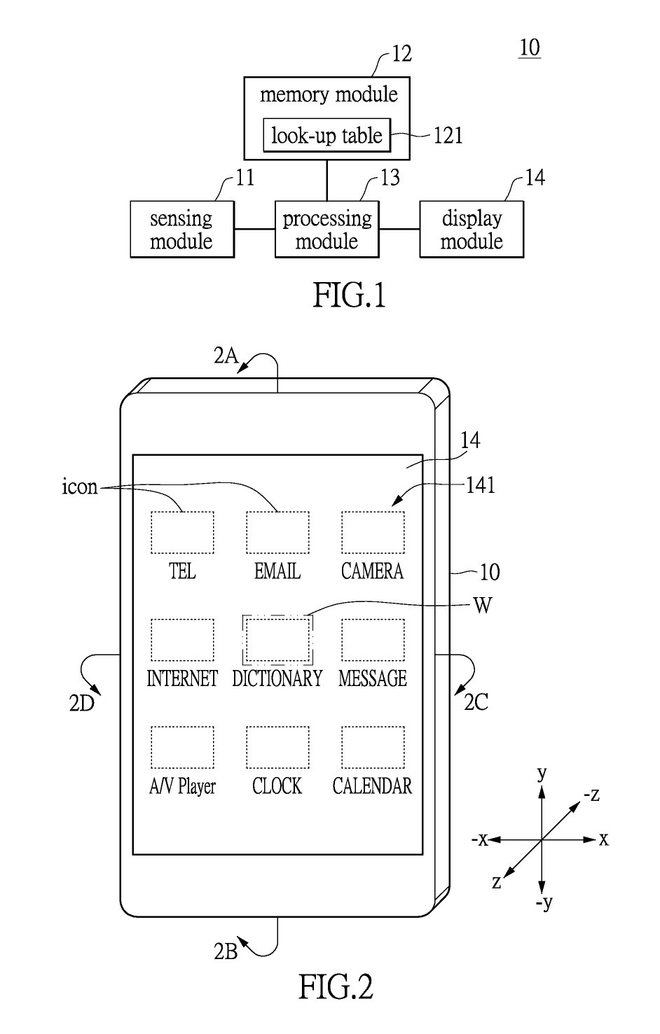

Firstly, please refer to FIG. 1, which is a block diagram showing a handheld device according to one embodiment of the present invention. The handheld device 10 includes a sensing module 11, a memory module 12, a processing module 13 and a display module 14. The processing module 13 is coupled to the sensing module 11, the memory module 12 and the display module 14. In the present embodiment, the handheld device 10 may be a smart phone, but the present invention is not limited thereto. Those with ordinary skill in the art would know the disclosure may be applied to other handheld devices such as personal digital assistants (PDAs), global positioning systems (GPSs) or tablet PCs.

The sensing module 11 is capable of detecting motions of the handheld device 10 such as shaking, vibrating, turning, rotating, or the like to correspondingly provide a sensing signal. In the present embodiment, the sensing module 11 may be a gyroscope, an accelerometer or a combination thereof. The present invention is not limited to these implementations of the sensing module 11.

The memory module 12 is capable of storing a plurality of applications (APPs) and a look-up table 121. The plurality of applications may be exemplified as web browsing programs, camera programs, document reading programs, alarm programs, telephony programs or any other applications. The present invention is not limited to these implementations of the memory module 12. The look-up table 121 is capable of recording a plurality of commands. In the present embodiment, the memory module 12 may be an embedded random access memory, a physical memory, an external memory stick or a combination thereof.

The processing module 13 is capable of receiving the sensing signal from the sensing module 11 and executing the plurality of applications. The processing module 13 controls the handheld device 10 to switch from a general operation mode to a motion operation mode according to the received sensing signal. Furthermore, after the handheld device 10 switches to the motion operation mode, the processing module 13 selects a command from the look-up table 121 stored in the memory module 12 according to the sensing signal received and the application being executed. Then, the processing module 13 controls the handheld device 10 to execute a specific function according to the selected command. In the present embodiment, the processing module 13 may include a plurality of transistors, be implemented by micro-controllers with suitable firmware, or be a software module implemented by a CPU with software. The present invention is not limited to these implementations of the processing module 13. The display module 14 is capable of correspondingly displaying different images according to the operation mode of the handheld device 10. In the present embodiment, the display module 14 is a liquid-crystal display (LCD) screen of the handheld device 10, but the present invention is not limited to this implementation of the display module 14. In other words, those with ordinary skill in the art may decide the implementation of the display module 14 according to practical demands.

In the present embodiment, when the user moves the handheld device 10 with a specific motion, the sensing module 11 correspondingly provides a sensing signal such as an acceleration signal or/and an angular velocity signal according to the motion of the handheld device 10. Then, the processing module 13 controls the handheld device 10 to switch the operation mode from the general operation mode to the motion operation mode, according to the sensing signal. When the handheld device 10 enters the motion operation mode, the sensing module 11 detects the motion of the handheld device 10 to correspondingly provide the sensing signal so that the processing module 13 selects a corresponding command from the look-up table 121 according to the application being executed and the sensing signal, and controls the handheld device 10 to execute a corresponding function according to the selected command.

When the handheld device 10 is in the motion operation mode, the processing module 13 correspondingly controls the handheld device 10 to execute a specific function according to the sensing signal received, and the applications are executed if the user moves the motion handheld device 10 applying various motions. Therefore, the user can easily control the handheld device 10.

On the other hand, in other embodiments, the user can switch the operation mode of the handheld device 10 to the motion operation mode by touching the screen of the handheld device 10 or by voice control if the handheld device 10 is provided with speech recognition, however, the present invention is not limited thereby.

Hereinafter, the operations of the handheld device 10 will be described in detail with reference to FIGS. 1 and 2. FIG. 2 is a schematic diagram showing an application menu displayed on a handheld device according to one embodiment of the present invention. When the user moves the handheld device 10 with an on-off motion, the processing module 13 controls the handheld device 10 to operate in the motion operation mode and display an application menu 141 according to the sensing signal received. The application menu 141 provides a plurality of icons and a window W. The plurality of icons respectively correspond to the plurality of applications stored in the memory module 12. When the handheld device 10 displays the application menu 141, the user moves the handheld device with a first motion so that the processing module 13 controls the handheld device 10 to execute one of the plurality of applications according to the sensing signal received.

When the user controls the handheld device 10 to move with the on-off motion again, the processing module 13 controls the handheld device 10 to exit from the motion operation mode according to the sensing signal received. It should be noted that, as stated above, the user does not necessarily have to move the handheld device 10 with the on-off motion to control the handheld device 10 to operate in the motion operation mode or exit from the motion operation mode. The user may also control the handheld device 10 by touching or by voice control to switch the handheld device 10 to operate in the motion operation mode and display the application menu 141 or exit from the motion operation mode.

Hereinafter, the on-off motion will be described in detail with reference to FIG. 2. The on-off motion may be performed by swaying the handheld device 10 downwards for a first pre-determined sequential number of times. For example, the handheld device 10 is swayed by the user along a −z axis (directed into a paper sheet on a desk as shown) for three times so that the handheld device 10 enters or exits from the motion operation mode. The above-mentioned first motion may have two stages. In the first stage, the handheld device 10 is rotated along direction 2A, direction 2B, direction 2C or direction 2D, so that the window W moves downwards, upwards, to left or to right to an icon to be selected. The rotation along direction 2A is defined as the handheld device 10 rotating counter clockwise around an x axis; the rotation along direction 2B is defined as the handheld device 10 rotating clockwise around the x axis; the rotation along direction 2C is defined as the handheld device 10 rotating clockwise around a y axis; and the rotation along direction 2D is defined as the handheld device 10 rotating counter clockwise around the y axis. In the second stage, the handheld device 10 is swayed downwards for a second pre-determined sequential number of times. For example, the handheld device 10 is swayed by the user along the −z axis so that the handheld device 10 executes an application corresponding to the icon selected by the window W.

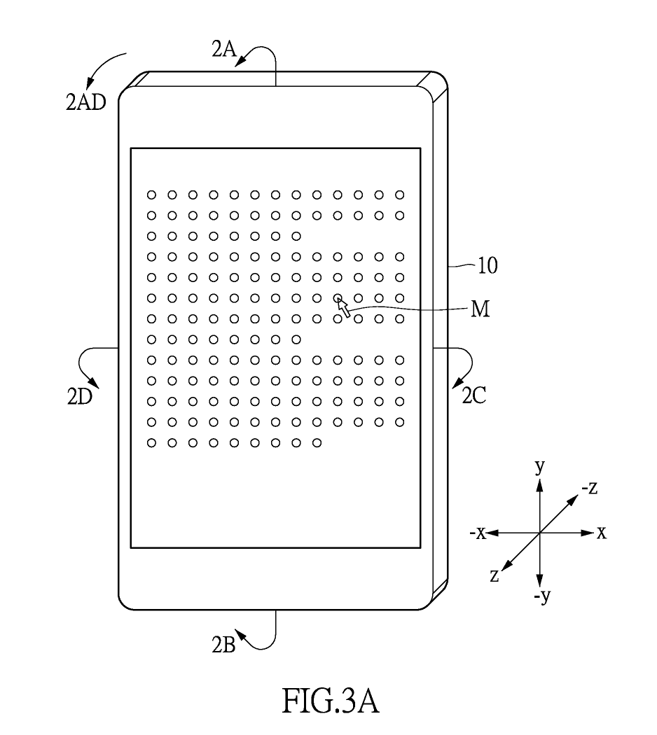

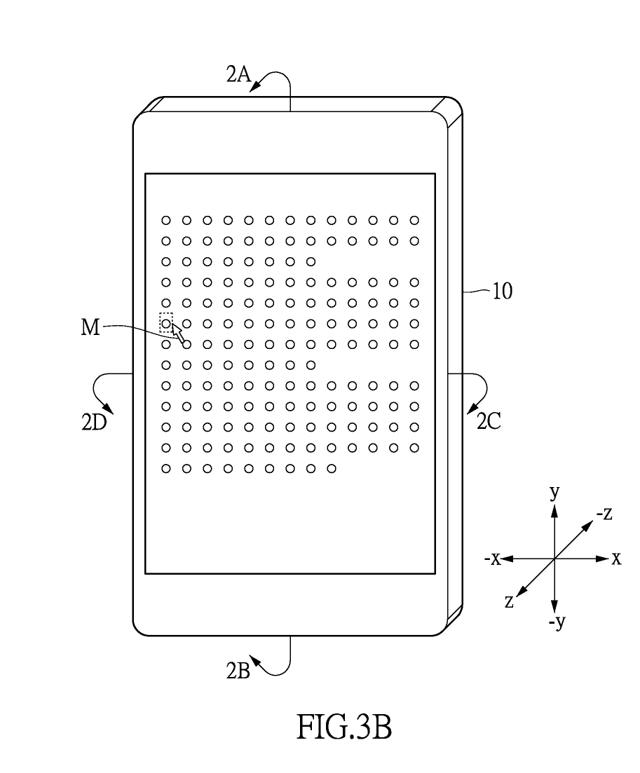

Afterwards, when the handheld device 10 executes the selected application, the user may control the motion of the handheld device 10 with various motions so that the handheld device 10 can be controlled easily. To further describe the handheld device and the methods of motion operation thereof in detail, the present invention is exemplified by one embodiment with reference to FIGS. 1, 3A and 3B. FIG. 3A is a schematic diagram showing a cursor displayed on a handheld device according to one embodiment of the present invention, and FIG. 3B is a schematic diagram showing selection and copying of words by the handheld device according to one embodiment of the present invention. After the handheld device 10 has selected a web browsing program or a document reading program to execute, the user may move the handheld device 10 with a second motion. The processing module 13 controls the handheld device 10 to display a cursor M on the display module 14 according to the sensing signal received. Then, the user may move the handheld device 10 with a third motion and the processing module 13 controls the handheld device 10 to move the cursor M to select and copy a segment of words or one word according to the sensing signal received.

More particularly, as shown in FIG. 3A, the second motion may be performed by rotating the handheld device 10 along direction 2AD. In other words, the handheld device 10 is rotated from the y axis to a −x axis by the user so that the display module 14 correspondingly displays the cursor M. The third motion may have four stages. In the first stage, the handheld device 10 is rotated along direction 2A, direction 2B, direction 2C or direction 2D by the user to move the cursor M to a first word in the segment of words to be selected. In the second stage, as shown in FIG. 3B, the handheld device 10 is swayed downwards by the user for a third pre-determined sequential number of times. For example, the handheld device 10 is swayed downwards by the user along a −Z axis for two times to select the first word in the segment of words. In the third stage, the handheld device 10 is rotated by the user along direction 2A, direction 2B, direction 2C or direction 2D so that the cursor M moves downwards, upwards, to left or to right to a last word of the segment of words to finish the selection of the segment of words. In the fourth stage, the handheld device 10 is swayed downwards by the user for a fourth pre-determined sequential number of times. For example, the handheld device 10 is swayed by the user along the −z axis for two times to control the handheld device 10 to copy the segment of words.

Moreover, when the handheld device 10 displays the cursor M, the user may also rotate the handheld device 10 along direction 2A, direction 2B, direction 2C or direction 2D to move the cursor M to a hyperlink icon on a web page displayed on the handheld device 10. Then, the handheld device 10 is swayed downwards for two times (to which the present invention is not limited) to access to a website through the hyperlink icon selected by the user.

Accordingly, by moving the handheld device 10 with the above specific motions, the user may control the handheld device 10 more easily and more instinctively so as to select and copy the words or the hyperlink icon on the website. It should be noted that, the handheld device 10 may also be moved with the above specific motions when the handheld device 10 executes other applications so as to select and copy the words or select other functions, to which the present invention is not limited.

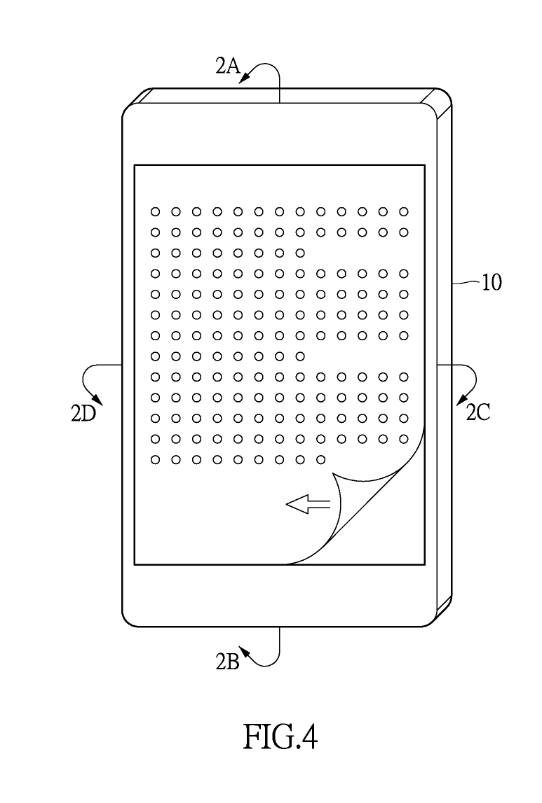

Furthermore, please refer to FIGS. 1 and 4. FIG. 4 is a schematic diagram showing document page turning executed by the handheld device according to one embodiment of the present invention. As shown in FIG. 4, when the handheld device 10 executes a document reading program, the user may move (or rotate) the handheld device 10 in a pre-determined direction (for example, direction 2C) so that the processing module 13 controls the handheld device 10 to perform forward page turning on the document displayed according to the sensing signal received. Alternatively, the user may also move (or rotate) the handheld device 10 in a pre-determined direction (for example, direction 2D) so that the processing module 13 controls the handheld device 10 to perform backward page turning on the document displayed according to the sensing signal received.

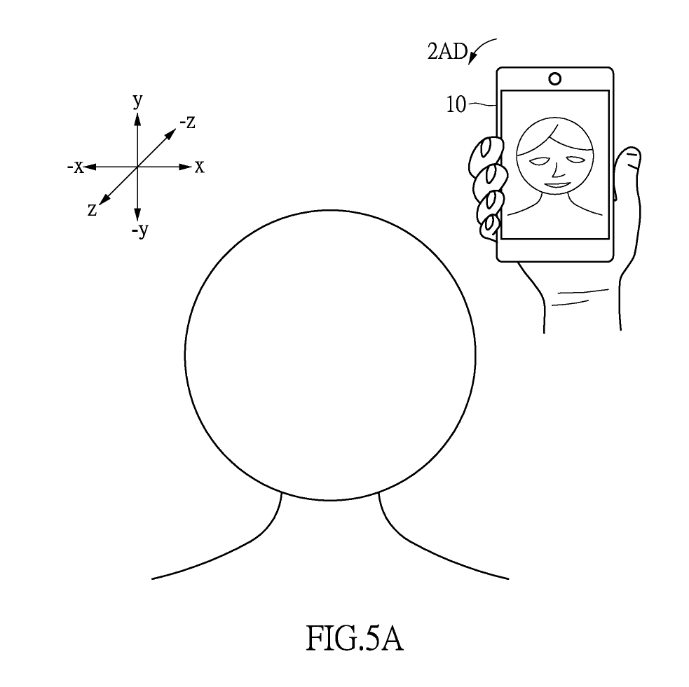

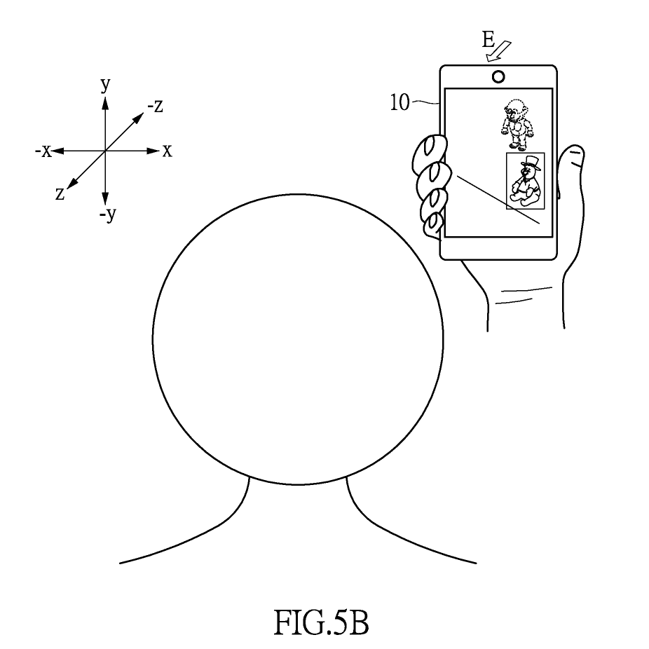

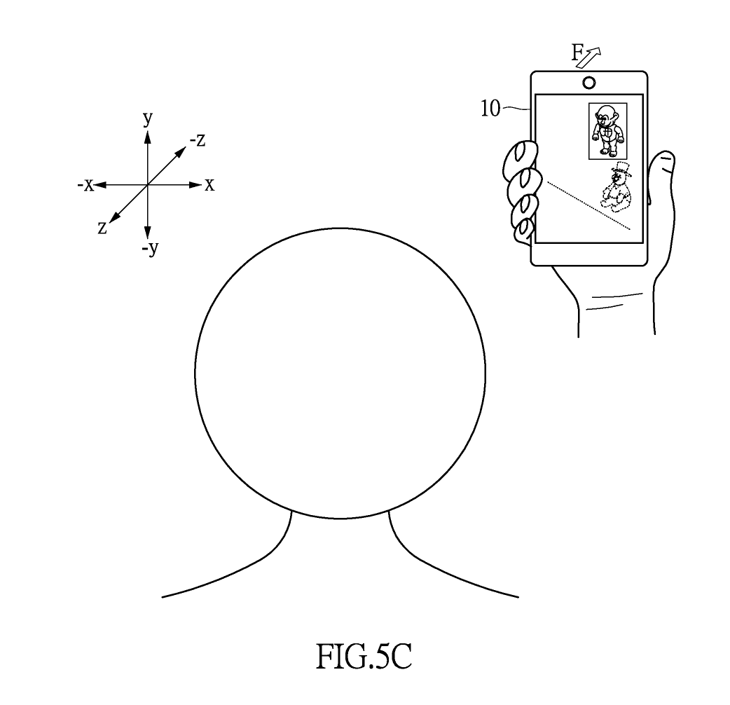

Furthermore, please refer to FIG. 1, FIG. 5A, FIG. 5B and FIG. 5C. FIG. 5A is a schematic diagram showing image capturing executed by a handheld device according to one embodiment of the present invention; FIG. 5B is a schematic diagram showing focusing on a foreground by a handheld device according to one embodiment of the present invention; and FIG. 5C is a schematic diagram showing focusing on a background by a handheld device according to one embodiment of the present invention. As shown in FIG. 5A, the user may adjust the angle of the handheld device 10 to display an image to be captured in the display module 15 when the handheld device 10 executes a camera program. Then, the user keeps holding the handheld device 10 for a first pre-determined period of time so that the processing module 13 determines that the handheld device 10 remains in a stable state during the first pre-determined period of time according to the sensing signal received. In other words, the variation of velocity values or/and angular velocity values detected by the sensing module 11 along the three axes does not exceed a threshold value during the first pre-determined period of time. Thereby, the processing module 13 determines that the handheld device 10 is in a stable state to control the handheld device 10 to capture an image. The captured image can be a selfie image captured by the front camera of the handheld device 10 or an image captured by the back camera of the handheld device 10. Moreover, the user may also rotate the handheld device 10 along direction 2AD to select from the front camera or the back camera of the handheld device 10. For example, the handheld device 10 selects the front camera correspondingly when the handheld device 10 is rotated along direction 2AD for a first time, and the handheld device 10 selects the back lens correspondingly when the handheld device 10 is rotated along direction 2AD again. In another embodiment, the user may also move the handheld device 10 in direction 2A or direction 2B to select the front camera or back camera of the handheld device 10. In one embodiment of the present invention, the present invention is not limited to any direction the handheld device 10 moves along.

Moreover, as shown in FIG. 5B, when the handheld device 10 executes a camera program, assuming that the handheld device 10 moves along a direction E towards the user (i.e., the handheld device 10 is moved by the user along the z axis, for example, directed out of a paper sheet on a desk), the processing module 13 controls the handheld device 10 to focus on the foreground according to the sensing signal received. On the other hand, as shown in FIG. 5C, assuming that the handheld device 10 moves along a direction F away from the user (i.e., the handheld device 10 is moved by the user along the −z axis), the processing module 13 controls the handheld device 10 to focus on the background according to the sensing signal received. Accordingly, even though the user does not press the buttons of the handheld device 10 or touch the display module 14 of the handheld device 10, the user may still proceed the function of focusing on the foreground or the background. It should be noted that, in another embodiment, the handheld device 10 focuses on the background when the handheld device 10 moves along the direction E towards the user and, on the contrary, the handheld device 10 focuses on the foreground when the handheld device 10 moves along the direction F away from the user. The present invention is not limited to the ways the user makes the handheld device 10 focus on the foreground or the background.

Furthermore, in other embodiments, when the handheld device 10 executes an alarm program to complete the time setting, the user may turn over the handheld device 10 to make the display module 14 (i.e., the display screen) face downwards if the handheld device 10 makes an alarm sound at a pre-set time. Then, the processing module 13 controls the handheld device 10 to stop making the alarm sound according to the sensing signal received. If the processing module 13 further controls the handheld device 13 to make the alarm sound again after a second pre-determined period of time, the user may turn over the handheld device 10 again to make the display module 14 of the handheld device 10 face upwards. Then, the processing module 13 controls the handheld device 10 to stop making the alarm sound according to the sensing signal received and not to control the handheld device 10 to make the alarm sound again.

Furthermore, in other embodiments, when the handheld device 10 executes a telephony program, for example, to display an incoming call, the user may pick up the handheld device 10 and hold it close to an ear so that the processing module 13 controls the handheld device 10 to answer the incoming call according to the sensing signal received. On the other hand, the user may turn over the handheld device 10 to make the display module 14 of the handheld device 10 face downwards. Thereby, the processing module 13 controls the handheld device 10 to hang up the incoming call according to the sensing signal received.

Moreover, in other embodiments, when the handheld device 10 executes an audio/video playing program, the user may move (rotate) the handheld device 10 in a pre-determined direction (for example, direction 2A, direction 2B, direction 2C and/or direction 2D in FIG. 2 to FIG. 3B). Then, the processing module 13 may control the handheld device 10 to correspondingly adjust the volume or switch channels according to the sensing signal received.

As stated above, when the handheld device 10 is in a motion operation mode, the user may easily control the handheld device 10 to browse a webpage or a document, select and copy words, focus and capture images, turn off and turn on an alarm, answer and hang up an incoming call, adjust the volume, switch the channel or execute other functions through various motions.

It should be noted that the present invention is not limited to the first to the fourth pre-determined sequential number of times. In other words, the first to the fourth pre-determined sequential number of times include at least one time. It should also be noted that the first pre-determined sequential number of times is different from the second to the fourth pre-determined sequential number of times to prevent the motion operation mode from being erroneously turned on or erroneously turned off Moreover, the present invention is not limited to the lengths of the first and the second pre-determined sequential periods of time. The present invention is not limited to the on-off motion and the modes of the first to the third motions. In other words, the handheld device 10 may be moved along various directions in different modes (such as swaying, shaking, vibrating, turning over, rotating or any other motions) to execute specific functions, which is within the scope of the present invention.

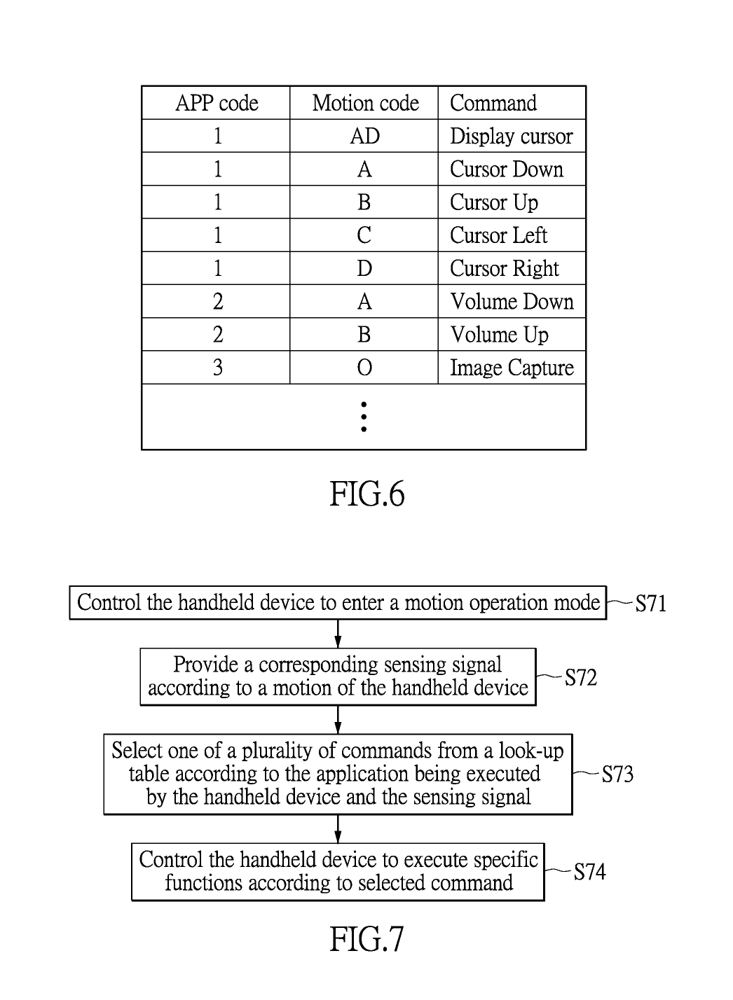

More particularly, please refer to FIG. 2 to FIG. 6. FIG. 6 is a schematic diagram of a look-up table according to one embodiment of the present invention. As shown in FIG. 6, the look-up table 121 records a plurality of application codes and a plurality of motion codes. The plurality of application codes respectively represent a plurality of applications stored in the memory module 12. For example, application codes “1”, “2” and “3” respectively represent in sequence a web browsing program, an audio/video playing program and a camera program. Moreover, the plurality of motion codes respectively correspond to various motions of the handheld device 10. For example, motion code “AD” represents rotation of the handheld device 10 along direction 2AD, and motion codes “A”, “B”, “C” and “D” respectively represent rotation of the handheld device 10 along direction 2A, direction 2B, direction 2C and direction 2D in sequence, and motion code “O” represents that the handheld device 10 is in a stable state during the first pre-determined period of time.

It should be noted that, as shown in FIG. 6, motion codes such as “AD”, “A”, “B”, “C” and “D” corresponding to an application code such as “1” may be regarded as a motion code set for an application such as the web browsing program: motion codes “A” and “B” corresponding to application code “2” may be regarded as a motion code set for the audio/video playing program; and motion code “E” corresponding to application code “3” may be regarded as a motion code set for the camera program. When the handheld device 10 executes an application, the processing module 13 selects one of the motion codes from a motion code set corresponding to the application according to the motion of the handheld device 10. Thereby, the processing module 13 may control the handheld device 10 to execute specific functions.

For example, when the handheld device 10 executes the web browsing program and rotates along direction 2AD, the processing module 13 provides a quantified signal by quantizing the sensing signal from the sensing module 11. Then, the processing module 13 selects a corresponding command to control the display module 14 to display the cursor M (as shown in FIG. 3A) according to application code “1” corresponding to the web browsing program and motion code “AD” corresponding to the quantified signal. On the other hand, when the handheld device 10 executes the web browsing program and rotates along directions 2A, 2B, 2C or 2D, the processing module 13 selects a corresponding command to move the cursor M downwards, upwards, leftwards or rightwards according to application code “1” and motion codes “A”, “B”, “C” or “D”.

Furthermore, for example, when the handheld device 10 executes the audio/video playing program and rotates along direction 2A or 2B, the processing module 13 selects a corresponding command to control the handheld device 10 to turn down the volume or turn up the volume according to application code “2” and motion code “A” or “B”.

Furthermore, for example, when the handheld device 10 executes the camera program and is in a stable state for a pre-determined period of time, the processing module 13 selects a corresponding command to control the handheld device 10 to capture an image according to application code “3” and motion code “O”.

It should be noted that, the present invention is not limited to the implementations of the look-up table 121. In other words, the look-up table 121 is only used to explain the operation of the handheld device 10. However, the present invention is not limited to the numbers and types of the application codes, the motion codes and the commands recorded in the look-up table 121. Moreover, in other embodiments of the present invention, the look-up table 121 may include a plurality of sub-tables. The plurality of sub-tables can be respectively stored in various memory blocks of the memory module 12 to speed up accessing the look-up table 121 for the processing module 13. It should be noted that, in other embodiments, the sensing module 11 can be replaced by an image capturing module (such as a camera module). In other words, the processing module 13 conducts image recognition such as head motion recognition, eye detection, face recognition, etc. according to the image captured by the image capturing module so that the handheld device 10 correspondingly executes a specific function. The present invention is not limited to the implementations of the sensing module 11. Please refer to FIG. 7, which is a flow chart of a motion operation method for a handheld device according to one embodiment of the present invention. The motion operation method may be executed in the handheld device 10 shown in FIG. 1 to FIG. 5C. Accordingly, please refer to FIG. 1 to FIG. 7 for the motion operation method including the steps below.

Firstly, in step S71, the user controls the handheld device 10 to enter a motion operation mode. As stated above, the user may move the motion handheld device 10 with an on-off motion to control the handheld device 10 to enter into the motion operation mode. Otherwise, the user may control the handheld device 10 by touch or voice control to control the handheld device 10 to operate in the motion operation mode

Afterwards, in step S72, the handheld device 10 executes an application and is moved with a specific motion so that the sensing module 11 provides a corresponding sensing signal.

Then, in step S73, the processing module 13 selects one of a plurality of commands from the look-up table 121 according to the sensing signal provided by the sensing module 11 and the application being executed.

And last, in step S74, the processing module 13 controls the handheld device 10 according to selected commands to execute specific functions.

The steps in the motion operation method of the handheld device have been described in detail with reference to FIG. 1 to FIG. 7 and thus the descriptions thereof are not repeated.

It should be noted that these steps in the embodiment as shown in FIG. 7 are only exemplary. The present invention is not limited to the sequence of the steps that may vary for different embodiments.

Furthermore, it should be noted that the steps in the motion operation method can be implemented by at least one segment of source codes and the segment of source codes corresponding to each of the steps can be recorded on a computer readable medium.

According to the above, one embodiment of the present invention provides a handheld device and a motion operation method that allows a user to control the handheld device through a motion of the handheld device without pressing the buttons or touching the screen of the handheld device. In other words, the user only has to move the handheld device with different motions so that the handheld device is able to execute specific functions to improve the convenience of controlling the handheld device.

The above-mentioned descriptions represent merely the exemplary embodiment of the present disclosure, without any intention to limit the scope of the present disclosure thereto. Various equivalent changes, alterations or modifications based on the claims of present disclosure are all consequently viewed as being embraced by the scope of the present disclosure.

What is claimed is:

1. A handheld device, comprising:
a memory module storing a plurality of applications;
a sensing module detecting a motion of said handheld device to correspondingly provide a sensing signal; and
a processing module coupled to said sensing module and said memory module to execute at least one of said plurality of applications and receive said sensing signal;
wherein when said handheld device enters a motion operation mode, said processing module controls said handheld device to execute a specific function according to said at least one of said plurality of applications being executed and said sensing signal received by said handheld device if said processing module receives said sensing signal from said sensing module.

2. The handheld device of claim 1, wherein said sensing module is a gyroscope, an accelerometer or a combination thereof.

3. The handheld device of claim 1, wherein said memory module further stores a look-up table, said look-up table recording a plurality of commands and said processing module selecting one of said commands from said look-up table according to said at least one of said plurality of applications being executed and said sensing signal received by said handheld device so that said processing module controls said handheld device to execute said specific function according to said selected one of said commands.

4. The handheld device of claim 3, wherein said look-up table further comprises a plurality of application codes and a plurality of motion code sets, said application codes respectively corresponding to said motion code sets and said applications, wherein each of said motion code sets respectively comprises a plurality of motion codes, and said motion codes respectively corresponds to said commands, wherein when said processing module receives said sensing signal, said processing module selects corresponding application codes according to said applications being executed by said handheld device and said processing module selects corresponding motion codes according to said application codes selected and said sensing signal received so that said processing module selects corresponding commands from said look-up table according to said application codes and said motion codes selected.

5. The handheld device of claim 1, wherein said handheld device displays an application menu providing a plurality of icons corresponding to said applications when said handheld device is in said motion operation mode so that a user moves said handheld device with a first motion to execute one of said applications.

6. The handheld device of claim 1, wherein when said handheld device executes a web browsing program or a document reading program, said processing module controls said handheld device to display a cursor according to said sensing signal received if said handheld device moves with a second motion and, after said cursor is displayed on said handheld device, said processing module controls said cursor to select a segment of words and copy said segment of words according to said sensing signal received if said handheld device moves with a third motion.

7. The handheld device of claim 1, wherein when said handheld device executes a camera program, said processing module controls said handheld device to focus on a foreground or focus on a background according to said sensing signal received if said handheld device moves in a direction towards a user and said processing module controls said handheld device to focus on said foreground or focus on said background according to said sensing signal received if said handheld device moves in a direction away from the user.

8. The handheld device of claim 1, wherein when said handheld device executes a camera program, said processing module controls said handheld device to capture an image according to said sensing signal received if said sensing module determines that said handheld device stays in a steady state during a first pre-determined period of time according to said sensing signal received.

9. The handheld device of claim 1, wherein when said handheld device executes a word reading program, said processing module controls said handheld device to perform page turning according to said sensing signal received if said handheld device is moved towards a pre-determined direction.

10. The handheld device of claim 1, wherein when said handheld device executes an alarm program and make an alarm sound, said processing module controls said handheld device to stop making said alarm sound according to said sensing signal received if said handheld device is turned over to make a display screen of said handheld device face downwards.

11. The handheld device of claim 1, wherein when said handheld device executes an audio/video playing program, said processing module controls said handheld device to correspondingly adjust the volume or switch the channel according to said sensing signal received if said handheld device is moved towards a pre-determined direction.

12. The handheld device of claim 1, wherein when said handheld device displays an incoming call, said processing module controls said handheld device to answer said incoming call according to said sensing signal received if said handheld device is picked up by a user and held close to an ear of the user.

13. The handheld device of claim 12, wherein if said handheld device is turned over by the user to make said display screen of said handheld device face downwards, said processing module controls said handheld device to hang up said incoming call according to said sensing signal received.

14. The handheld device of claim 1, wherein the user moves said handheld device with an on-off motion so that said processing module controls said handheld device to execute said motion operation mode according to said sensing signal received.

15. A motion operation method applicable in a handheld device, said handheld device being used for executing a plurality of applications, wherein said handheld device executes said motion operation method when said handheld device enters a motion operation mode and said motion operation method comprises the steps of:
providing a corresponding sensing signal according to a motion of said handheld device; and
controlling said handheld device to execute a specific function according to at least one of said plurality of applications being executed by said handheld device and said sensing signal.

16. The motion operation method of claim 15, further comprising steps of:
selecting a command from a plurality of commands recorded in a look-up table according to said at least one of said plurality of applications being executed by said handheld device and said sensing signal, wherein said look-up table is stored in said handheld device; and
executing said specific function by said handheld device according to said command selected.

17. The motion operation method of claim 15, wherein said handheld device displays a cursor, copies a segment of words, focuses on a foreground, focuses on a background, captures an image, performs page turning, makes an alarm sound, adjusts the volume, switches the channel, answers or hangs up an incoming call according to said command selected.

18. A computer readable medium recording at least a segment of source codes, using a handheld device to read said source codes to execute the motion operation method of claim 14.
